(19) United States
(12) Patent Application Publication
(10) Pub. No.: US 2008/0152553 A1
(43) Pub. Date: Jun. 26, 2008

(54) DISSOCIATION CHAMBER FOR AN APPARATUS FOR THE NEUTRALIZATION OF TOXIC AND HAZARDOUS MATERIALS BY MEANS OF PLASMA FLOW

(75) Inventor: Roger Remy, Albuquerque, NM (US)

Correspondence Address: DARBY & DARBY P.C., P.O. BOX 770, Church Street Station, New York, NY, 10008-0770, US

(73) Assignee: Aerospace Consulting Corporation Spain, S.L., Barcelona (ES)

(21) Appl. No.: 11/615,196

(22) Filed: Dec. 22, 2006

(51) Int. Cl. B01J 19/08

(52) U.S. Cl. 422/186.04

(57) ABSTRACT

The chamber is characterized for having means for the increase of the temperature and density of the flow of plasma in determined zones of the plasma flow inside of the dissociation chamber, to locally increase temperature and density of the plasma as well as to regulate the time of residence of the particles to be dissociated, being at least one of said pinched zones of the plasma flow arranged before the final expansion area opposite to the collecting surface of the dissociated particles within the dissociation chamber.

This invention refers to a dissociation chamber for an apparatus for the neutralization of toxic and hazardous materials by means of plasma flow.

U.S. Pat. No. 7,026,570 discloses an apparatus in form of a transportable unit with a chamber for the treatment of toxic waste in order to receive canister drums containing the waste to be eliminated, the apparatus having the capacity to create and control the direction of the plasma flow at a temperature higher than 10000° K. surrounding totally the container in order to enhance its complete dissociation.

The present invention is referring to the U.S. Pat. No. 7,026,570 B2, as the state of the art, with the object of improving the process of the dissociation of the molecule of the material in transit into the dissociation chamber, the plasma core, therefore, by means of raising the plasma temperature and its density in a given zone of its flow in a pre-determinant conditions in order to obtain the control of the shape of the plasma core and flow characteristics and the control of the sequence of the tome residence of the said molecule within the plasma core.

According to the discovery carried out by the inventor to ensure a higher level of dissociation of the molecules in an adequate period of time residence within the core of the plasma flow it has been found necessary to improve the characteristics of the structure of the plasma flow, the plasma temperature to more than 15000° K. and its density in one or more zones within the plasma core.

Therefore, the improvements introduced by the present invention refer especially to the creation of one or more narrowing or pinching zones in the plasma flow having a controlled shape with the objective of increasing the density and temperature of the plasma creating some kind of pinched zones, one of which will be placed just before the zone with non-thermal plasma equilibrium immediately before to the collecting area of the dissociation chamber. The new chamber will incorporate means in order to control the intensity of the above-defined pinching that is a magnetic pinching, taking into account the type of material to be dissociated, especially its chemical characteristics, having the possibility to adequately change locally the density and temperature of the plasma.

The invention will incorporate as well means to control the magnetic narrowing or pinching of the plasma flow using the variation of the magnetic intensity within the area in which such pinching is to be produced in order to create the appropriate plasma flow eliminating negative effects.

Also the invention will incorporate means to control the length of the magnetic narrowing or pinching in the zone in which the flow of plasma suffers such pinching, taking into account the type of materials to be dissociated in order to ensure the appropriate density and flow of the plasma.

Also the present invention will incorporate in the dissociation chamber a means to control said magnetic pinching or narrowing of the flow of plasma to create in the collecting area a large zone with non-thermal plasma equilibrium just in the vicinity of the collecting area to ensure an efficient collecting of different species which have been separated.

All together the present invention is based on the application of the plasma constriction that controlling the external shape of the plasma core and its flow the plasma temperature and its density therefore, within the dissociation chamber in a gradual shape constituting one or more intermediate zone with a constrained, pinched or narrowed section, before the final expansion of the plasma flow in the collecting area, an important and controlled increase of temperature is obtained in the narrow or pinched zones which, without wishing to be bound by any limitations, the inventor evaluates in approximately 20-25% above the previously obtained dissociating temperatures, that is allowing a working temperature range of 8000 to 15000° K., reducing at the same time the turbulent areas which could give ground to losses in the performance.

For its better understanding, schematic drawings are enclosed to the description only with the purpose of explaining the invention but with no limitative effects.

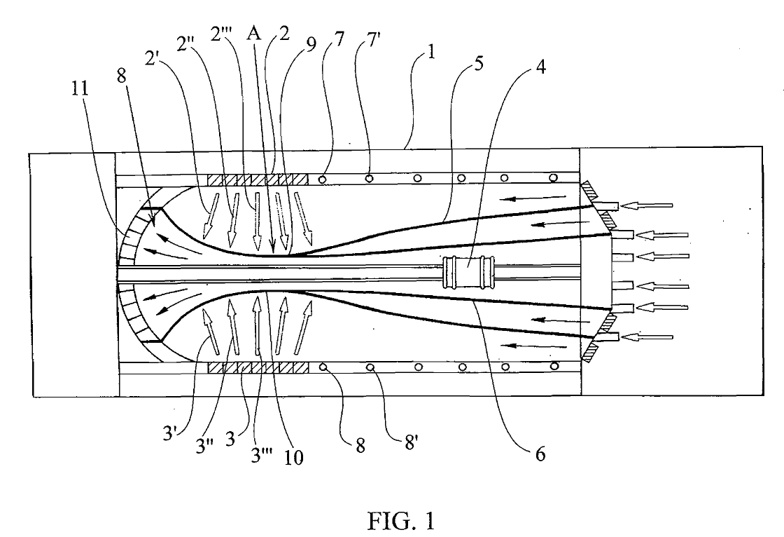

FIG. 1 shows schematically a cross-section of a dissociation chamber incorporating the present invention.

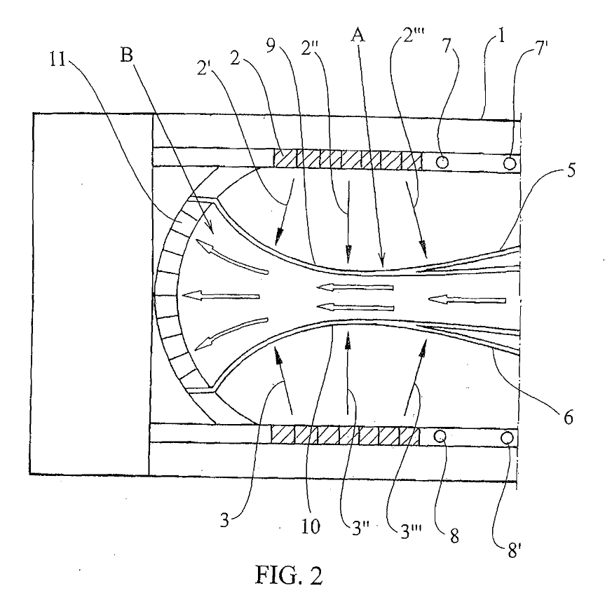

FIG. 2 shows also schematically to a larger scale a zone with a narrowing or pinching of the flow of plasma.

As shown in the figures the dissociation chamber 1 has specific magnetic means in the points 2 and 3 which have been shown in the figures but which in reality represent a surrounding arrangement in respect to the flow of plasma, having said magnetic means controlled strength and direction which have been shown just for understanding by arrows -2′-, -2″-, -2′″- . . . and -3′-, -3″-, -3′″- . . . so that the mass of plasma which is used for the complete dissociation of the matter contained in the drum 4 requires a control shape characterized by way of example by the notional external lines 5 and 6 which represent as well a narrowed or pinched area of the flow of plasma. In the figures are shown as well the antennas of radio frequency -7-, -7′- as well as -8-, -8′- being in general arranged all magnetic means in order that the flow of plasma is submitted to a smooth narrowing in order not to create swirls, giving ground finally to a pinched or narrowed area which has been designated with a letter -A- which is defined by the represented curved concave areas corresponding to a longitudinal section and which have been indicated by numerals -9- and -10-. After said pinching or narrowing zone -A- the plasma flow will expand anew in the zone -B- opposed to collector -11- in order not to reduce the performance in the collecting of the dissociated particles.

The different parts of the dissociation chamber -1- which have not been expressly numbered or described correspond to those of the FIGS. 8 and 18 of U.S. Pat. No. 7,026,570 which is incorporated to this description as reference.

By means of the present invention it will be ensured that the dissociation of the materials contained in the drum -4- will be much more complete and that the treatment will be better adequate to the nature of said materials in the first place due to the increase of the temperature and density of plasma in the zone or zones -A-. Without wishing to be bound by any limitation the inventor believes that the increase of temperature may be of 20/25% or more in relation to the temperatures foreseen in the main Patent.

Moreover, the invention will also make possible to control the sequence of residence time in the different zones of the plasma flow obtained by the present invention.

As may be observed in the figures of the drawings which have been annexed as examples, at least a zone -A- characterized by the controlled narrowing or pinching of its cross-section is directly opposed to the expansion area with non-thermal plasma equilibrium.

As it is obvious, although only one pinching area has been shown for the flow of plasma, various successive pinching zones could be arranged in case of need, being arranged at least one of said pinching zones for the plasma flow before the final expansion zone opposed to the collecting surface within the dissociation chamber.

The dissociation chamber according to the present invention will incorporate means for the control of the magnetic pinching as to the intensity mainly taking into consideration the type of materials to be dissociated, that is the chemical characteristics of the material, having therefore the possibility of changing accordingly the density and temperature of the plasma.

Also the present invention will have means to control the magnetic pinching or narrowing of the plasma flow by means of changing the magnetic strength in the pinching zone to create the appropriate flow and eliminating at the same time all negative effects.

Further, the present invention will incorporate means to control the length of the magnetic pinching area that is zone -A- taking into account the type of materials to be dissociated in order to ensure the adequate density and flow of plasma.

The invention has been described based on the schematic annexed drawings but these have not to be taken into account as limitative because it is obvious that any expert in the field, after learning the method which has been explained here above, will be capable of introducing variations which could be by way of equivalents comprised within the scope of the invention as per the following claims.

### REFERENCES

The inventor is willing to furnish the following list of references appertaining to the field of technique of the present invention.
“Plasma Physics” European Fusion Development Agreement, E.U. Fusion Programme
2. “Plasma production and Heating in VASIMR—A Plasma Engine for Space Exploration”, F. Chang Diaz, J. Squire, J. Shebalin, Advanced Space Propulsion Laboratory; 31st EPS Conference on Plasma Physics, London, Jun. 28-Jul. 2, 2004.
3. “Dynamo-Free Plasma in the Reversed Field Pinch”, J. K. Anderson, T. M. Biewer, C. B. Forest, R. O'Connell, S. C. Prager and J. S. Sarff, Department of Physics, University of Wisconsin-Madison, Feb. 13, 2004.
4. “Recent Results on Turbulence and MHD Activity Achieved by Reflectometry”, R. Sabot (Association Euratom-CEA, France), F. Clairet (Association Euratom-CEA, France), G. D. Conway (Max-Planck-Institute, Germany), T. Gerbaud (Association Euratom-CEA, France), S. Hacquin (Association Euratom CFN-IST, Portugal), P. Hennequin (LPTP, CNRS, Ecole Polytechnique, France), S. Heuraux (LPMIA, CNRS, Universite Henri Poincare, France), C. Honore (LPTP, CNRS, Ecole Polytechnique, France), G. Leclert (LPIIM, CNRS, Universite de Provence, France), A. Sirinelli (Association Euratom-CEA, France), L. Vermare (Max-Planck-Institut, Germany), A. Truc (LPTP, CNRS, Ecole Polytechnique, France), Jun. 22, 2006.
5. “Electron Bernstein Wave Emission from an Overdense Reversed Field Pinch Plasma”, P. K. Chattopadhyay, J. K. Anderson, T. M. Biewer, D. Craig and C. B. Forest, Department of Physics, University of Wisconsin, R. W. Harvey, CompX, California, A. P. Smimov, Moscow State University, Russia; Nov. 20, 2001.
6. “Active MHD Control Experiments in RFX-Mod” S. Ortolani, Consorzio RFX, Associzione EURATOM-ENEA Sulla Fusione, Italy; Jun. 22, 2006.
7. “Computation of Turbulence in Magnetically Confined Plasmas” B. Scott, Max-Planck-Institut, Germany, Jun. 21, 2006.
8. “Particle Transport in Discharges with Active Mode Control in the Reversed Field Pinch Experiment RFX-Mod” R. Loenzini, F. Auriemma, A. Alfier, P. Innocente, R. Pasqualotto, D. Terranova, Consorzio RFX, Associazione EURATOM-ENEA, Italy, Jun. 23, 2006.
9. “Influence of Radial Electric Field on High-Beta Plasma Confinement in the Gas Dynamic Trap”, P. A. Bagryansky (Budker Institute of Nuclear Physic, Russia), E. L. Soldatkina (Novosibirsk State University, Russia), Jun. 19, 2006.

1. Dissociation chamber for an apparatus for the neutralization of toxic and hazardous materials by means of plasma flow, wherein the said chamber has means for the increase of the temperature and density of the flow of plasma in determined zones of the plasma flow inside of the dissociation chamber, to locally increase temperature and density of the plasma as well as to regulate the time of residence of the particles to be dissociated, being at least one of said pinched zones of the plasma flow arranged before the final expansion area opposite to the collecting surface of the dissociated particles within the dissociation chamber.

2. Dissociation chamber for an apparatus for the neutralization of toxic and hazardous materials by means of plasma flow, according to claim 1, wherein the said chamber has in the dissociation chamber surrounding the flow of plasma only one narrowing or pinching zone of the plasma flow, formed by means having regulatable intensity and direction, arranged in a surrounding form as to the flow of plasma, to obtain an adjustable magnetic effect on the flow of plasma to obtain a gradual and smooth narrowing of the flow of plasma corresponding in its shape and section to the materials to be dissociated.

3. Dissociation chamber for an apparatus for the neutralization of toxic and hazardous materials by means of high temperature plasma, according to claim 1, wherein the said chamber has means to control length of the narrow or constraining/pinching zone of the plasma core for its adjustment according to the material to be dissociated.

4. Dissociation chamber for an apparatus for the neutralization of toxic and hazardous materials by means of plasma flow, according to claim 1, wherein the said chamber has means to control the length of the narrow or pinched zone of the plasma flow for its adjustment according the material to be dissociated.
